(19) United States
(12) Patent Application Publication
(10) Pub. No.: US 2012/0190001 A1
(43) Pub. Date: Jul. 26, 2012

(54) AUTOMATED COGNITIVE TESTING METHODS AND APPLICATIONS THEREFOR

(75) Inventors: Stanley Scott Knight, Oakville (CA); Konstantine Zakzanis, Markham (CA)

(73) Assignee: Hemisphere Centre for Mental Health & Wellness Inc., Oakville (CA)

(21) Appl. No.: 13/358,123

(22) Filed: Jan. 25, 2012

Related U.S. Application Data
(60) Provisional application No. 61/435,901, filed on Jan. 25, 2011.

(51) Int. Cl. G09B 7/00

(52) U.S. Cl. 434/362

(57) ABSTRACT

An automated cognitive test that provides screening, scoring and real time results based on comparing the test results to updated normed results. The test can be self administered. The questions are randomly chosen from a selected database. Customizable reports may be generated from the test results and used in industry.

### FIELD OF THE INVENTION

The present invention claims benefit of priority to U.S. patent application Ser. No. 61/435,901, which was filed on Jan. 25, 2011, and which is incorporated by reference as if fully recited herein.

The present invention relates to the automated screening, scoring and real time on the spot reporting of cognitive impairment and the commercial use of the report so generated in industry.

### BACKGROUND OF THE INVENTION

With an aging population, there will be higher instances of dementia and other cumulative cognitive disorders. The consequences of this condition will be felt in increased accidents and emergencies and eventually significant monetary costs to society.

In the prior art, paper & pencil cognitive tests are administered by a physician at the “doctor's office” or the like. The test is then sent offsite to be professionally scored and later the results are relayed back to the person via the doctor. This is a lengthy process and does not give an immediate or real time result. It also means that the person has to travel to the health care professional in order to be tested.

Delayed diagnosis prevents people from getting early treatment. Cognitive impairments may be seen in the early stages of Alzheimer's disease and other dementias well before there is any evidence of structural changes in the brain that can be seen using neuro-imaging. Cognitive impairment is also common after sports related concussion injuries and is present in a myriad of psychiatric (e.g. depressions, schizophrenia) and medical disorders (e.g. kidney dysfunction). Cognitive impairment is being viewed as a greater predictor of disability than the symptoms that accompany these disorders as for example, the depressed symptoms of a person with depression.

Early detection and identification of cognitive impairment can facilitate early intervention. Medications and other strategies can aid to slow the progression of dementia and enable persons to remain independent with a higher quality of life for a longer duration.

As the population continues to age, 2011 marks the year that Baby Boomers will hit the age of 65. The senior population is increasing rapidly in both absolute numbers and percentage of the population. There will be an increase in the number of senior drivers on the road. Professional opinion concurs that dementia is a major problem among the elderly. The number of drivers likely driving with dementia will continue to increase. Although not all drivers with dementia are necessarily dangerous, some may continue driving well into the disease process and are, or will soon become, dangerous.

According to Transport Canada, in 1988, 10% of seniors were involved in fatal collisions. In 1998, that figure increased to 15%. In Canada, there are about 2.7 million drivers who are seniors. There are approximately half a million Canadians with Alzheimer's disease or related dementia and that number is expected to double over the next 30 years. The United States has a population 10 times that of Canada. The Alzheimer's Association estimates that there are 5.4 million Americans who have Alzheimer's an estimated related cost of $183 billions dollars annually.

Most Departments or Ministries of Transportations do not routinely require remedial driver testing for seniors until an advanced age such as 70 years of age in California and 80 years of age in Ontario. Even then, such testing does not include a screen for dementia deficits related to driving. Early identification of cognitive impairment of drivers would greatly increase general road safety.

Early identification of cognitive impairments has many benefits, not only to the individual, but also to society as a whole.

### SUMMARY OF THE INVENTION

According to one aspect of the present invention, a method is disclosed for automatically processing an application made by a person to a third party for the purpose of obtaining the third party's license, consent or approval to the application for an intended purpose. The method includes the steps of administering a computer implemented cognitive test to a person at a test location and time. The test consists of a group of questions randomly selected from a question database and includes questions specific to the intended purpose. Answers are obtained from the person to the group of questions, and are evaluated in real time to obtain a test score which is compared to a normed score to obtain a test result. The test result is used to inform a decision for continuing or adjourning or terminating the application process.

According to another aspect of the invention, the test location is provided with communication means. The test score is communicated to and stored in a remotely located database through the communication means. Additionally, the normed score is calibrated in response to the stored test scores.

According to yet another aspect of the invention, the test location is a kiosk unit and the kiosk unit is provided with communication means. The test score is communicated to and stored in a remotely located database through the communication means. Additionally, the normed score is calibrated in response to the stored test scores.

According to yet other aspects of the invention, the test is available in multiple languages, the test score is determined by the accuracy of the answers and the time required to obtain the answers and the application is for obtaining or renewing a driver's license, insurance coverage or employment.

According to another aspect of the invention, a method is provided for automatically evaluating a person's ability to continue a physical activity upon sustaining a suspected head injury at a location. The method includes the steps of administering a computer implemented cognitive test to a person at the location and time following the injury. The test consists of a group of questions randomly selected from a question database including questions specific to the injury. Answers are obtained from the person to the questions and are evaluated in real time to obtain a test score which is compared to a normed score to obtain a test result. The test result is used to inform a decision on whether to permit the person to continue the physical activity after the injury or to stop. Alternatively, the test may be administered at a time immediately following the injury.

According to yet another aspect of the present invention, a method is provided for automatically testing and recording a person's cognitive ability at a time or location. The method includes the steps of administering a computer implemented cognitive test to a person at the location or time and consists of a group of questions randomly selected from a question data base. Answers are obtained from the person to the questions and are evaluated to obtain a test score which is compared to a normed score to obtain a test result which is stored in a database.

Further features of the invention will be described or will become apparent in the course of the following detailed description.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a flow chart illustrating the various steps of a test according to one embodiment according to the present invention.

FIG. 2 is a flow chart illustrating accessibility to the Central Research Server Process.

FIG. 3 is a flow chart illustrating the connectivity between the Local Server and the Central Research Server.

FIG. 4 is a process schematic flow chart illustrating the steps, sequences and various functions of the Local Server.

FIG. 5 is a process schematic flow chart illustrating the steps, sequences and various functions of the Central Research Server.

FIG. 6 is a flow chart of the database design of the Local Server.

FIG. 7 is a flow chart of the database design of the Central Research Server.

FIGS. 8a, 8b, 8c are a sample Brain Screen Question Guide.

FIG. 9 is a sample public domain Normative Table.

FIG. 10 is a flow chart illustrating an embodiment of the present invention referable to a Driver's License Renewal process.

FIG. 11 is a flow chart illustrating an embodiment of the present invention referable to insurance underwriting.

FIG. 12 is a flow chart illustrating an embodiment of the present invention referable to private health care facilities

FIG. 13 is a flow chart illustrating an embodiment of the present invention referable to pre and post employment screens.

FIG. 14 is a flow chart illustrating an embodiment of the present invention referable to athletic physical activity endeavours.

FIG. 15 is a sample “Green” or Pass Outcome Report.

FIG. 16 is a sample “Yellow” or Caution Outcome Report.

FIG. 17 is a sample “Red” or Fair Outcome Report.

### DESCRIPTION OF THE PREFERRED EMBODIMENTS

The invention relates to the commercial use of an automated cognitive test to screen for dementia and other neurodegenerative diseases. The test can be administered at any location by any medically trained or untrained person and delivers immediate real time on the spot results in the form of a report or score. The test de-medicalizes the screening process for cognitive disorders such as dementia and post concussive syndrome. The test is scientifically normed and validated across multiple stratified populations and is made available in many of the most commonly used languages in North America. The resulting Reports are fully customizable and can provide Industry specific reports defined by specific parameters such as gender, age and demographics. Person specific reports can also be generated for baseline and trending purposes.

The test is adaptable and is able to accommodate and process new information by way of updates as research improves with new findings in related fields pertaining to cognition become available. Researchers can access the Central Research Server and collect and sort all of the test results anonymously for future research purposes in cognitive functioning in various fields related to mental health. This research tool is able to improve and adapt the current version of the cognitive test being administered thus creating a continuous cycle of improving the cognitive tests through research.

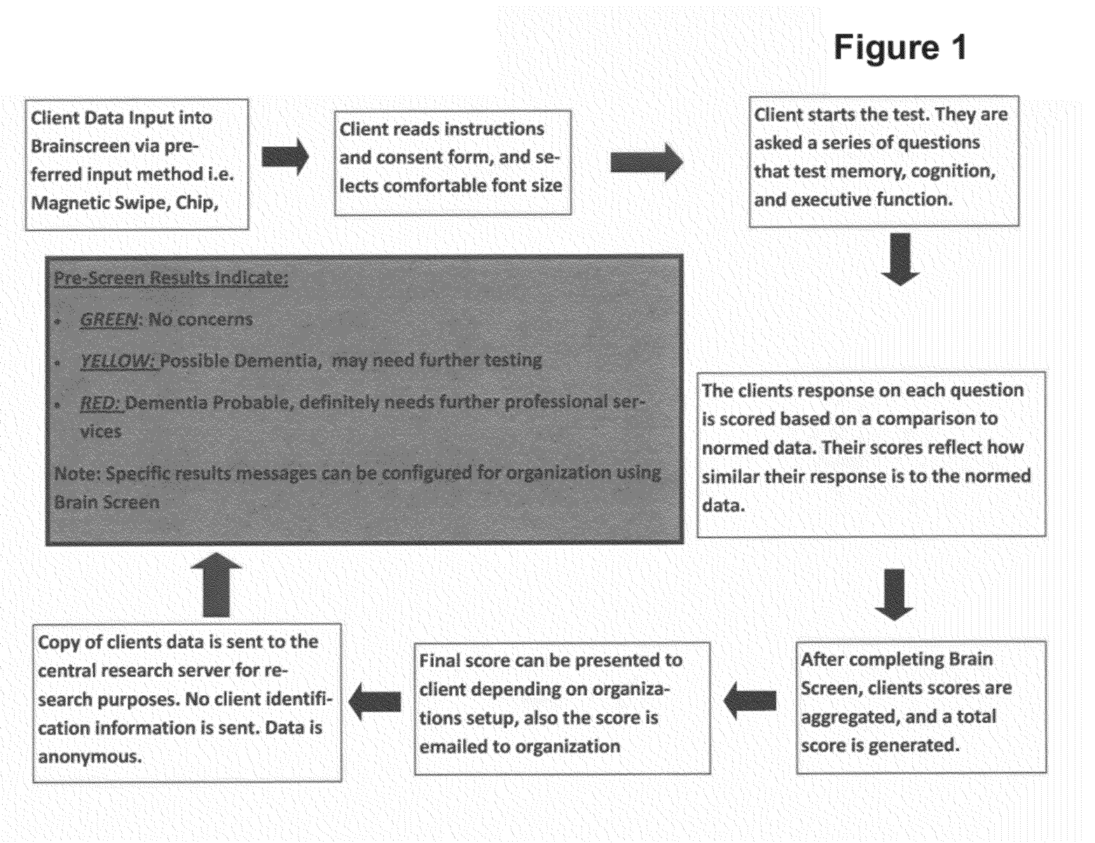

Referring to FIG. 1, the flowchart illustrates the various testing steps and elements of a preferred embodiment according to the present invention. The automated test can be administered at any location. Relevant personal data for the client/person/patient (Person) being tested is entered. The Person reviews the instructions and selects a comfortable font size for the test. The Person takes the cognitive test by answering a series of randomly selected questions from a specified database and submits the responses. The Person's response is scored based on a comparison to normed data. The Person's final score is generated based on the aggregate of accuracy and response time across all the questions and a total score and corresponding Report is generated. A copy of the Report may be sent to an interested organization, to the Central Research Server, and/or to the Person through email or other electronic means. The Person receives an immediate result indicating, by way of example, a colour score such as

(1) Green—No concern,

(2) Yellow—Possible concern requiring further testing, or

(3) Red—Serious concern definitely requiring further professional services.

The cognitive test according to the present invention may be administered on a variety of suitable computer system platforms. By way of example, the computer software or firmware instructions may be installed on stationary or mobile computing devices or license dispensing kiosk. The cognitive testing may be administered via the Internet or downloaded as an application from a remote location. The test is also designed with human factor engineering, making it accessible via touch sensitive systems that do not have a keyboard, such as on a kiosk.

The computer instructions comprising the invention maybe divided between: the Local Server and the Central Research Server. The Local Server may be any personal computing device or an organization's personal server. The programming languages used include PHP, Javascript, AJAX, CSS, HTML, DHTML. For data query, MySQL programming maybe used.

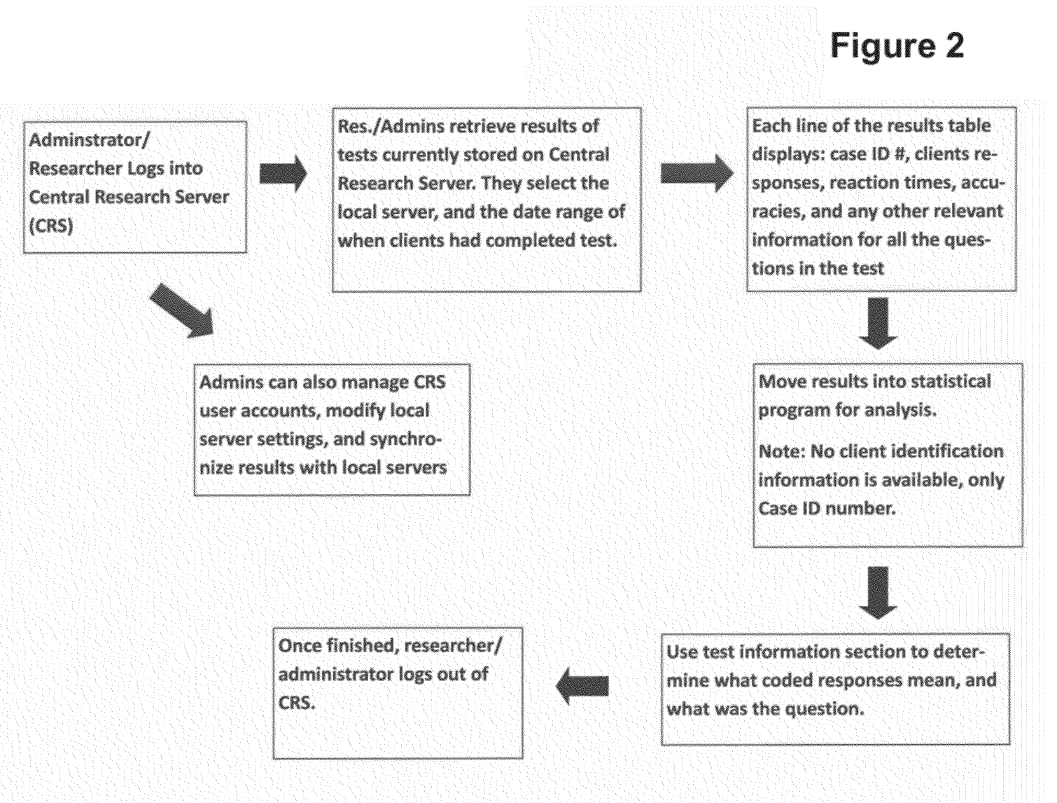

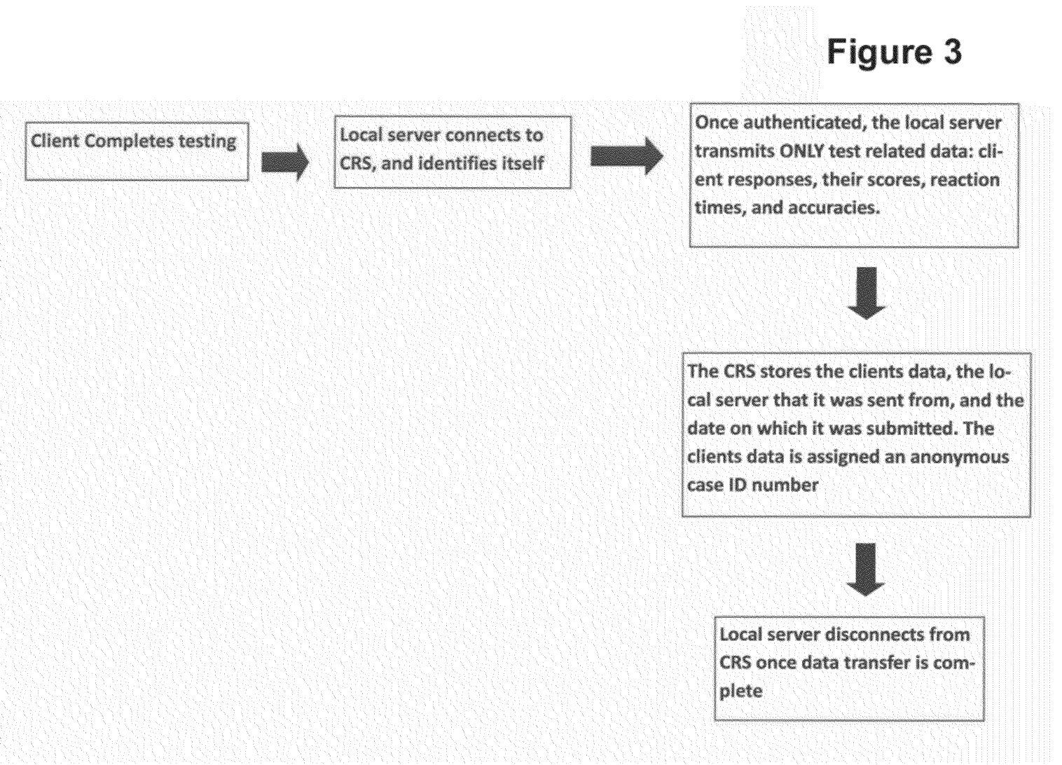

Referring to FIGS. 2 and 3, the flow charts illustrate the steps taken by the Central Research Server as well as the interaction between the Local Server and the Central Research Server. Upon completion of the test or at any specified or desired time interval, the Local Server connects to the Central Research Server through the Internet and transmits only the test related data. Researchers accessing the Central Research Server are able to select date ranges and access relevant data for further analysis. Researchers do not have access to any personal identification information, as only Case ID numbers are displayed.

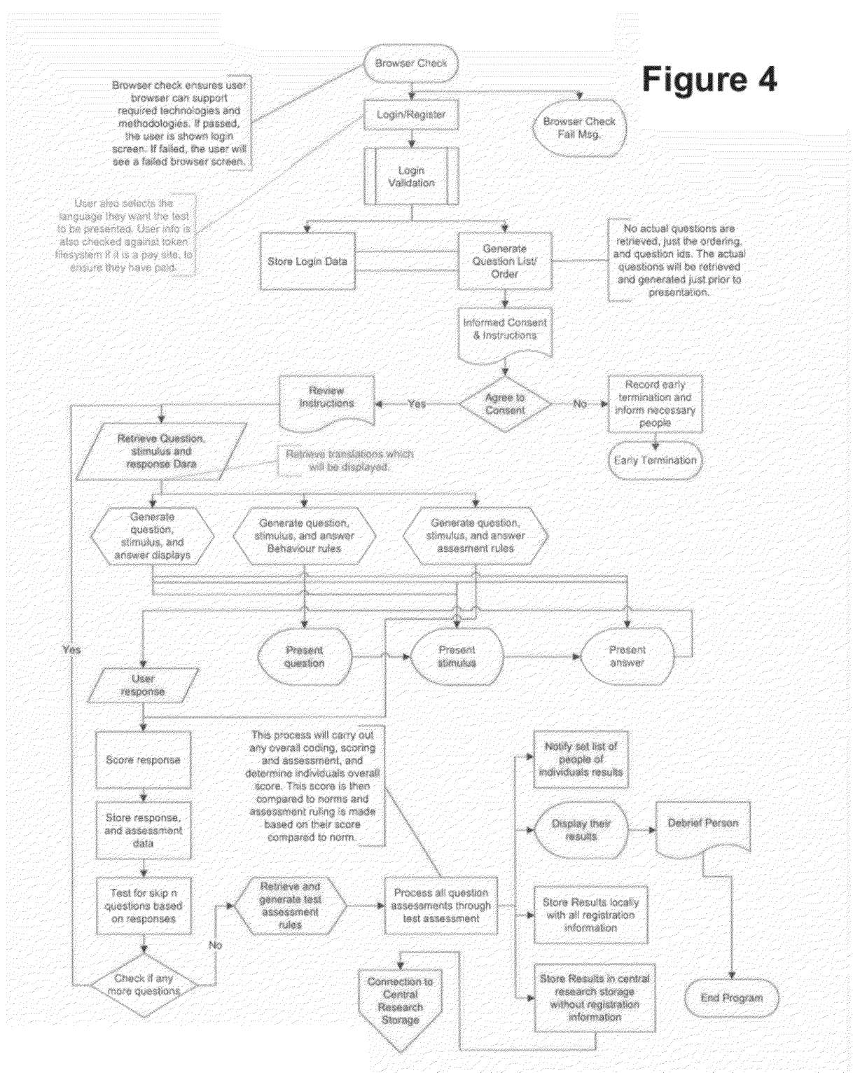

Referring to FIG. 4, an example process schematic flow chart indicating the steps, sequences and various functions for the Local Server is shown by way of example. The person administering the test first logins and reviews the instructions. Alternatively, the test may be self administered. The test is administered by having the Person answer a group of randomly chosen group of questions from a larger database of questions. The test is scored in real time, and a test result is received by the Person.

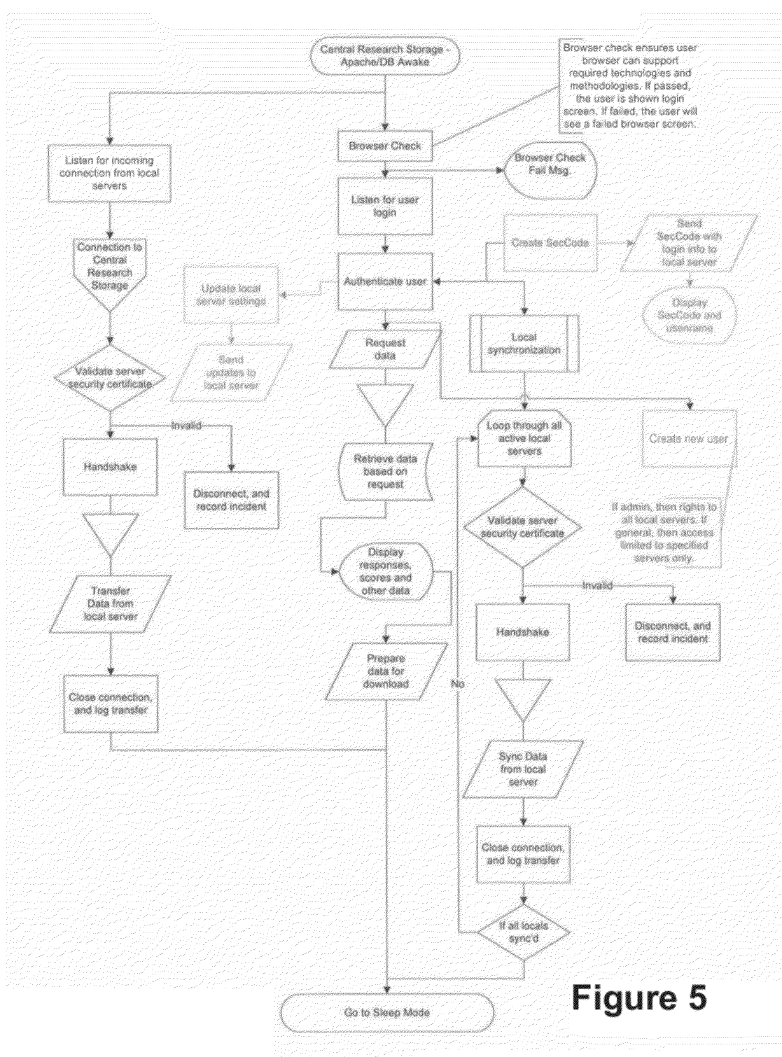

Referring to FIG. 5, a sample process schematic flow chart indicating the steps, sequences and various functions of the Central Research Server is shown by way of example. The Central Research Server collects all the data from the local servers and builds a database of results for educational and research use and updates the Normative Tables for more accurate results. The Central Research Server not only retains the Person's responses, but also their reaction times and their accuracies. For example, Researchers are able to analyze the data in desired categories to identify patterns or trends.

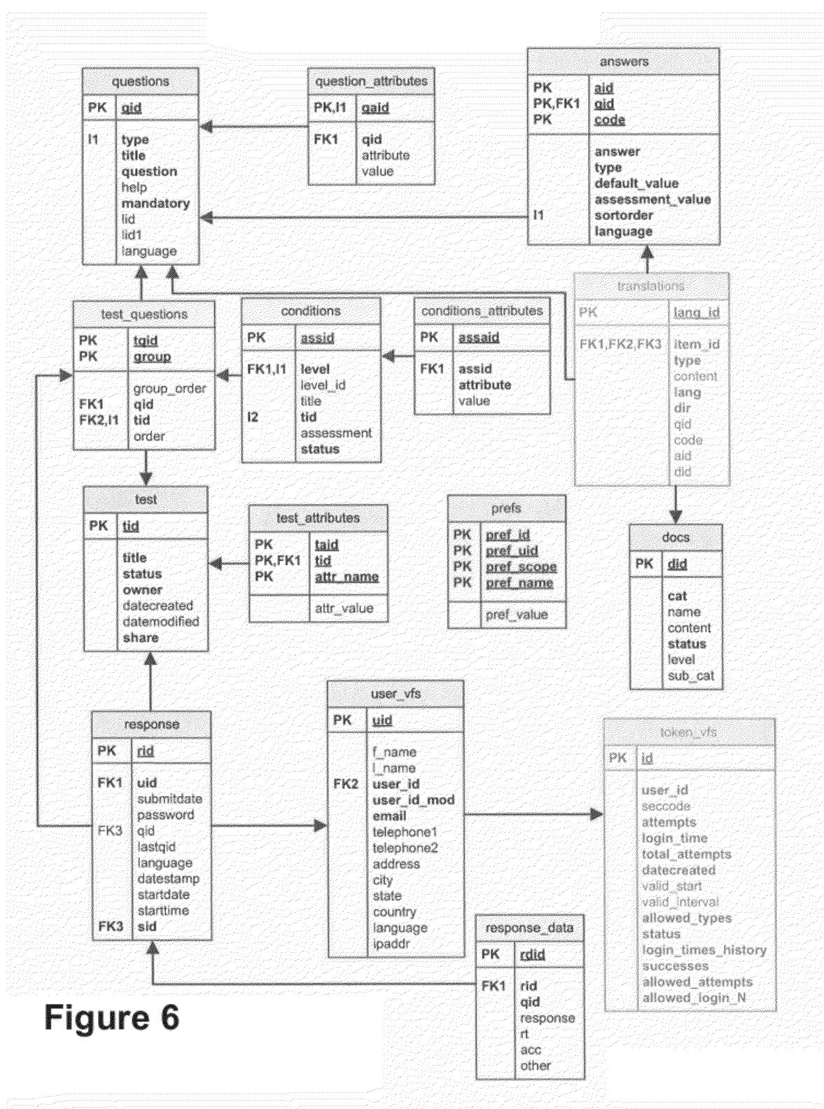

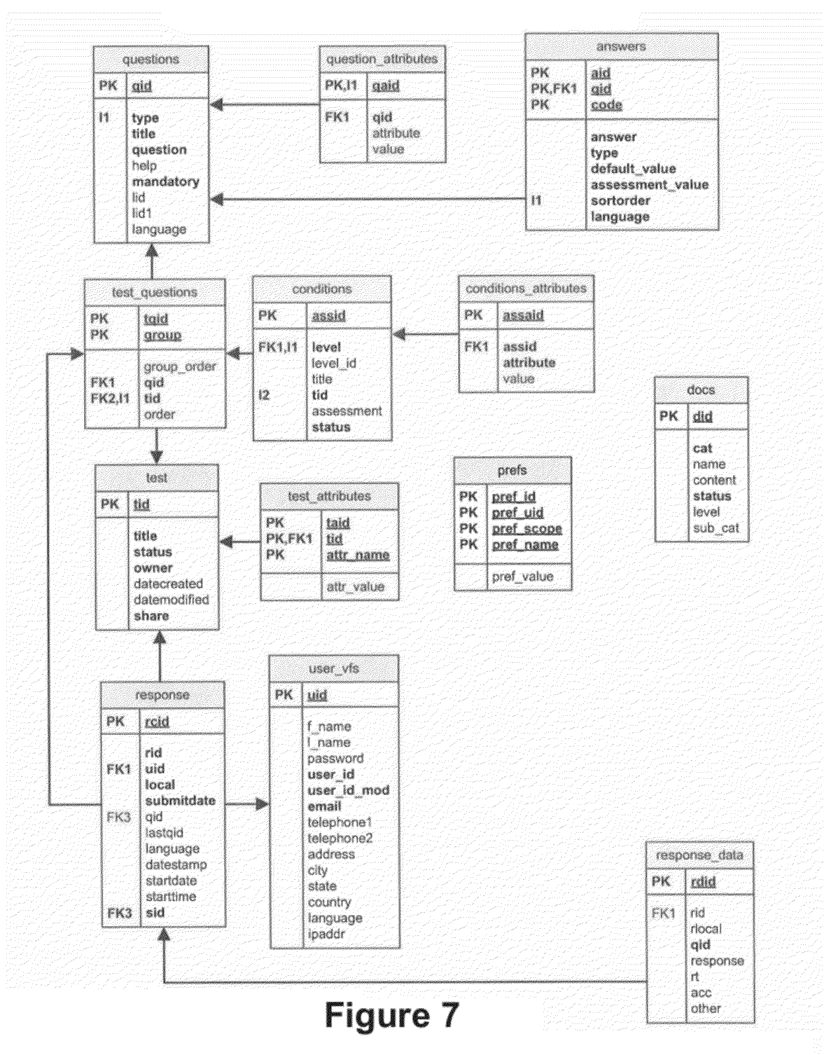

FIGS. 6 and 7 illustrate how the database is organized and designed to implement the test by choosing questions randomly from a larger database of questions and how all of the results are stored in the Central Server. Randomization in psychological testing is very important as it alleviates several statistical and psychological anomalies such as response bias. Randomization of the questions also prevents a Person from memorizing the correct responses to the test and improving their performance on the test by repeatedly taking the test. This eliminates what is called the “practice effect”. Persons can take the test multiple times with minimum impact from practice effects, thereby allowing a baseline to be established and their progress to be tracked.

The cognitive test commences by asking questions such as name, age, date of birth, gender, and like desired information to establish a baseline for that particular Person. This baseline will determine how to score the test results for the particular Person.

The test is adapted for age and to persons with visual disabilities. The testing display can be adjusted to increase or decrease the presentation size of the test to a comfortable level for the Person.

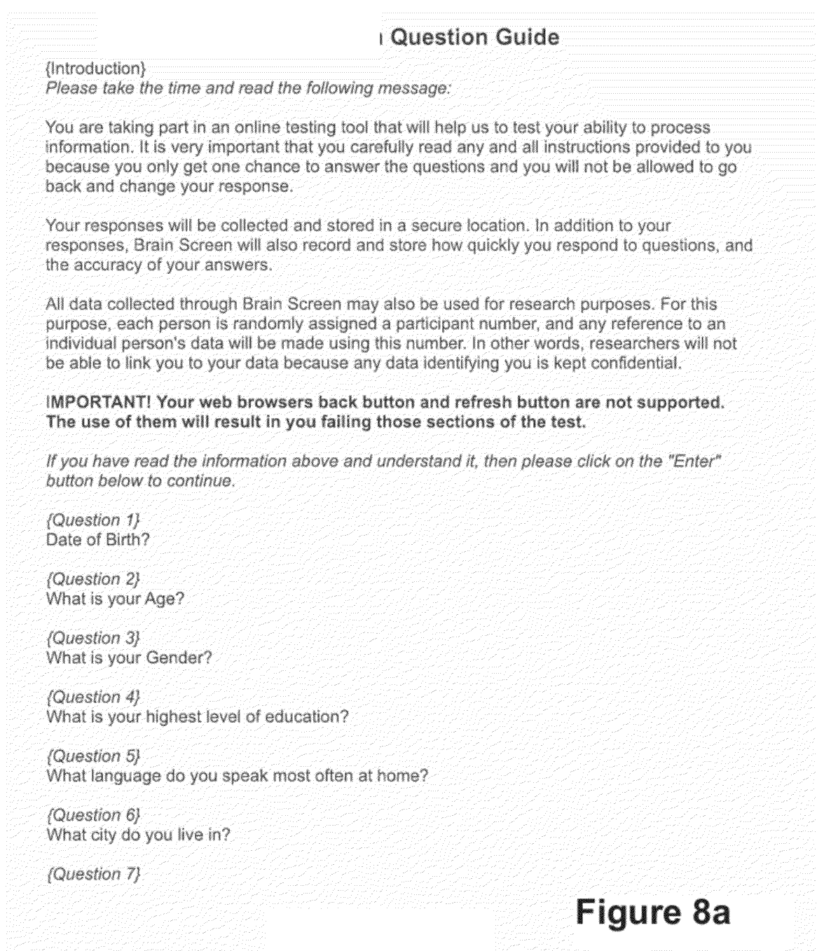

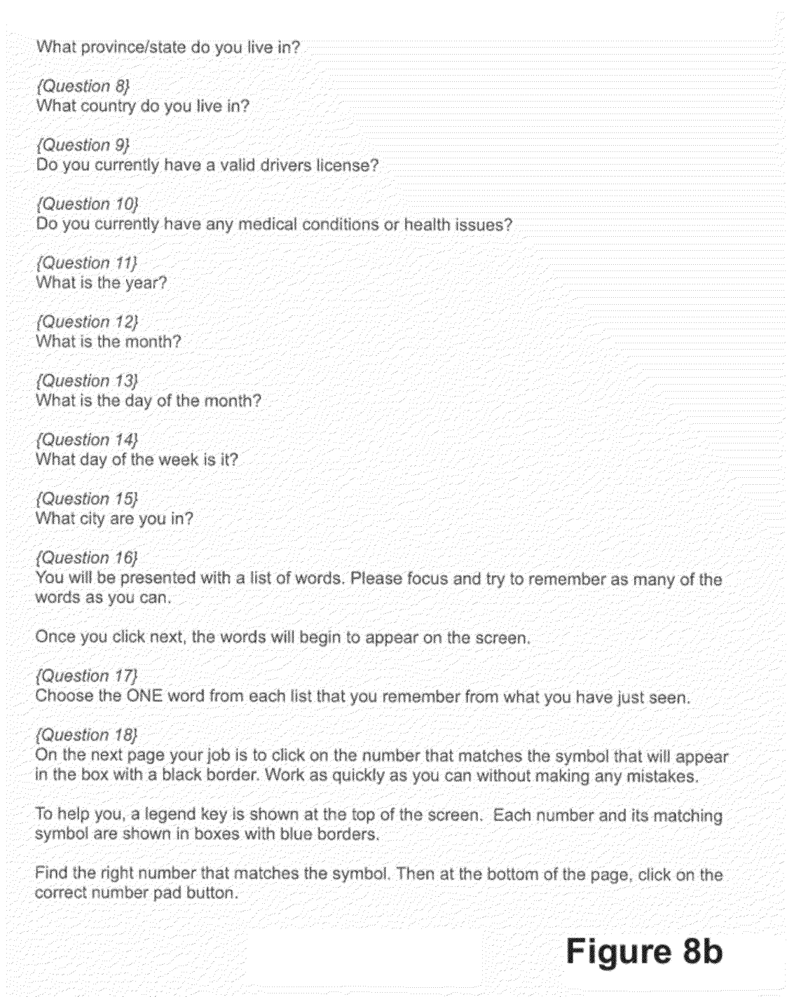

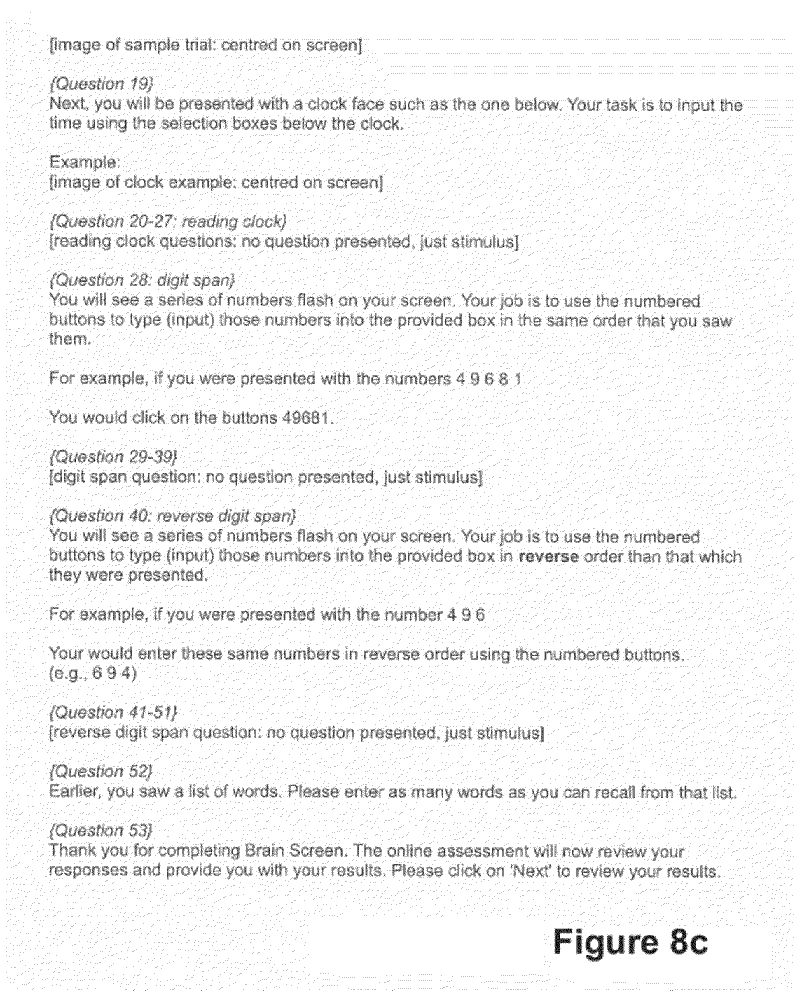

The cognitive questions include memory, matching, clock work, sequencing, verbal learning and retrieval deficits by way of example. A Sample Brain Screen™ Test Question Guide is included as FIGS. 8a, 8b and 8c.

Security features are embedded within the test to ensure that a Person cannot go back to change an answer to a previous question. If a Person attempts to go back in a web browser, the system will log their response on the current question as “0” and move on to the next question ensuring that the test taker cannot go back and change answers. Responses of Persons taking the test are logged on a question by question basis so that no information is lost. Further security features include logging IP address, test start and completion dates and times. The full responses are downloaded to the Central Research Server upon test completion, or when an administrator logs into the Central Research Server and updates the data repository.

Test abort features are also automatic within the test. If test activity is not seen by the system for a predefined period of time, determined by age and other specific factors to the Person and application, the system will alert the Person to respond before a time limit has been reached. If a response is not detected, the system will automatically save the progress of that test and exit the system.

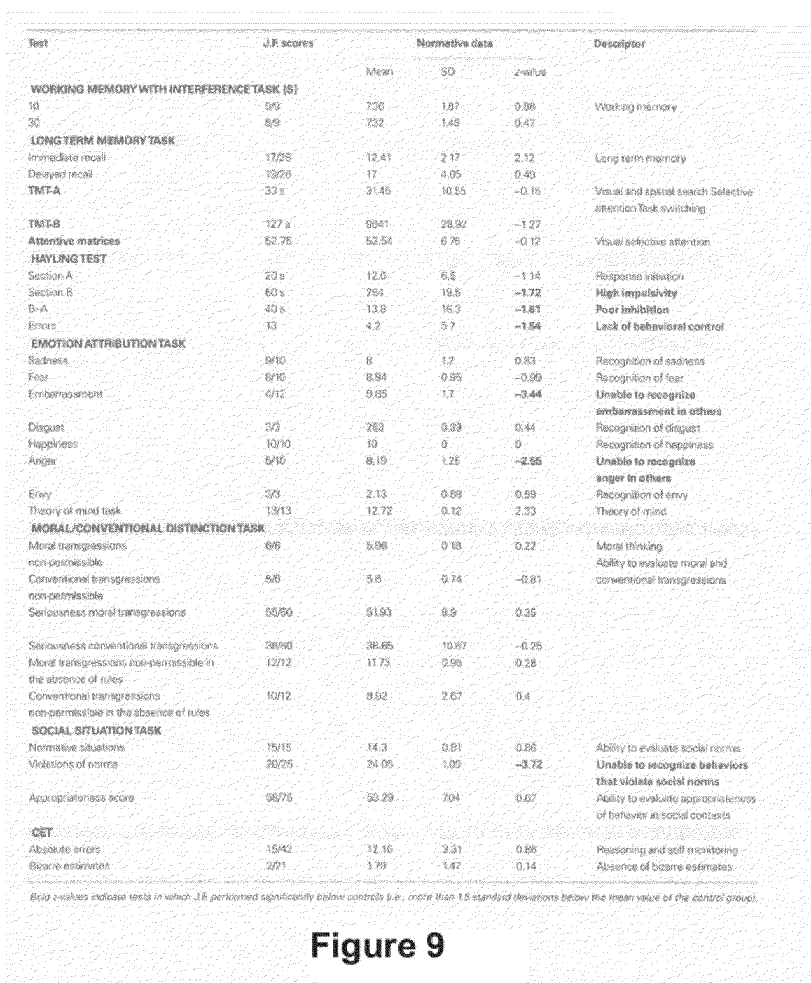

The scoring of the test is scored based on an aggregate assessment of accuracy and response time across all questions and taking that total score and comparing it to the Normative Tables. For example, the test results of a person over 50 will only be compared to those normed test results of other persons over 50. The normed results can also be stratified by gender, education and specific age ranges by way of example. If the score for the Person falls below a “cut” score, a “fail” or “red” score is indicated. If the score falls in the “overlap” of the distribution of normed scores between known patients and healthy controls, a “caution” or “yellow” score is indicated. If the score of the person falls above the cut score, a “pass” or “green” score is indicated. A sample Normative Table is included as FIG. 9.

The base sample for the normative table was established by only including the test results of persons who have no history of cognitive disorder secondary to a neurodegenerative disorder such as Alzheimer's disease or traumatic brain injury, never been involved in a motor vehicle collision that resulted in chronic injury, or no history of substance abuse or dependencies. From the base sample, the mean and standard deviation were calculated and the sample was stratified by age. The test interpretation and cut scores are constantly evolving as more and more users take the test and each result is stored and added to the Central Research Server allowing for more specifically stratified normative data.

Research is being conducted by administering the test on persons with known profound cognitive impairments secondary to Alzheimer's disease and other dementia conditions. Further research and improvement of the test will arise by administering the test to persons with known conditions such as concussion, Multiple Sclerosis, Schizophrenia, and depression.

The test is made available, by way of example, in 20 of the most commonly used languages in North America in addition to English. The available languages are as follows: English, French, Mandarin, Cantonese, Punjabi, Spanish, Italian, Ukrainian, Arabic, German, Tagalog, Vietnamese, Portuguese, Urdu, Polish, Korean, Persian, Russian, Tamil, Greek and Gujarati. Additional languages can be added in the future. Persons taking the test can choose their native language for the cognitive test or the language with which they are most comfortable. The language chosen is important for the purposes of language selection and also following instructions and performing some aspects of the tests such as Memory Word Recall to eliminate language, cultural and linguistic biases in the test.

Because the test according to this invention is automated, it no longer requires the presence of a physician or like professional to administer the test. The response times to specific questions once determined by stopwatch rounded to the nearest second is more accurately recorded by the computer. The cognitive test can be administered in any desired location on the spot by any responsible person or even self administered. The test according to this invention removes the barriers that previously delayed or prevented the public from being tested for “medical” dementia or neurodegenerative diseases and makes cognitive testing readily and easily available. This allows for appropriate and immediate action to be taken based upon the results of the test.

In one embodiment of the invention, the test is administered to drivers as a part of a driver's license application or renewal processes with a view to improve road safety since dementia is a growing concern with an aging population of motor vehicle drivers. Early detection is important in preventing accidents caused by drivers with a cognitive impairment. Drivers can be screened for symptoms or indicators of dementia and neurodegeneration in tandem with appropriate government licensing department issuance or license renewal protocols. The test according to this invention may be made available and administered at a stand alone off site kiosk where a driver's license is being renewed by a person.

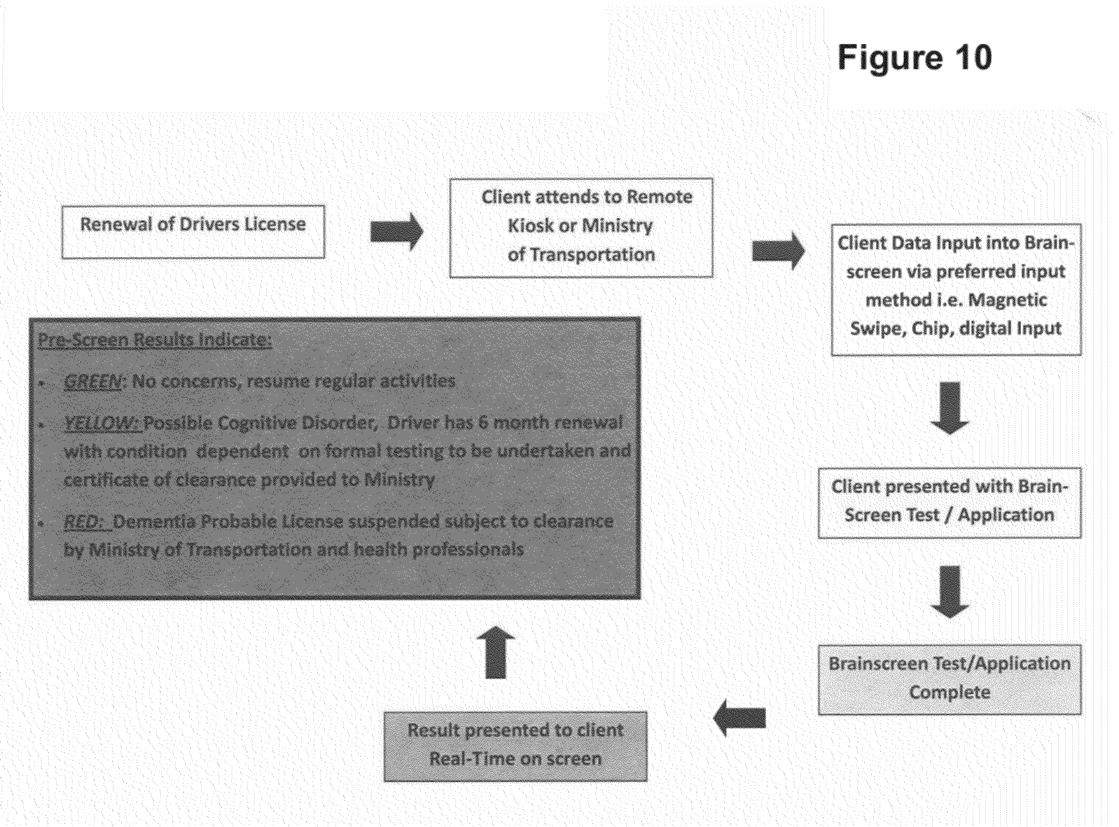

FIG. 10 is a flow chart illustrating an embodiment of the invention as with application to the driver's license renewal process. At the designated time of license renewal, the person attends to the renewal at an appropriate kiosk. As a part of the renewal process, the person would be required to complete the cognitive test in real time at the kiosk. The questions for the cognitive test are randomly selected from a pool of selected questions with specific sensitivity to driving. For example, aspects of a test for a cognitive disorder would include learning and memory test, attention and working memory test, digit symbol information processing speeded test, test of visual field and visual spatial ability and a reaction time test.

A real time test result is given to the Person which determines the outcome of the renewal process, either allowing that Person to continue with the renewal process and obtain a new license, or giving a warning and requiring the person to continue the renewal process with an agent to determine whether they need to return within a specified time frame for additional or different testing, or the test can indicate real concerns and the license would not be renewed at that time. The test would aid in identifying drivers who may be a risk to themselves and others and improve road safety for all drivers. At the same time, the result of the test would be communicated to the appropriate agency overseeing driver's license renewal. The test results of the Person may also be measured against their own past performances, thus creating a baseline for the individual for year over year results.

Analogously, the invention may have application for the automobile insurance industry. The test may be used during the underwriting of policies to assist in the identification of pre-existing conditions or hazards that may influence the underwriting process. The invention may also be used during a motor vehicle accident claim investigation to aid in confirming or denying allegations of, for example, post concussive syndrome following a whiplash or other injury.

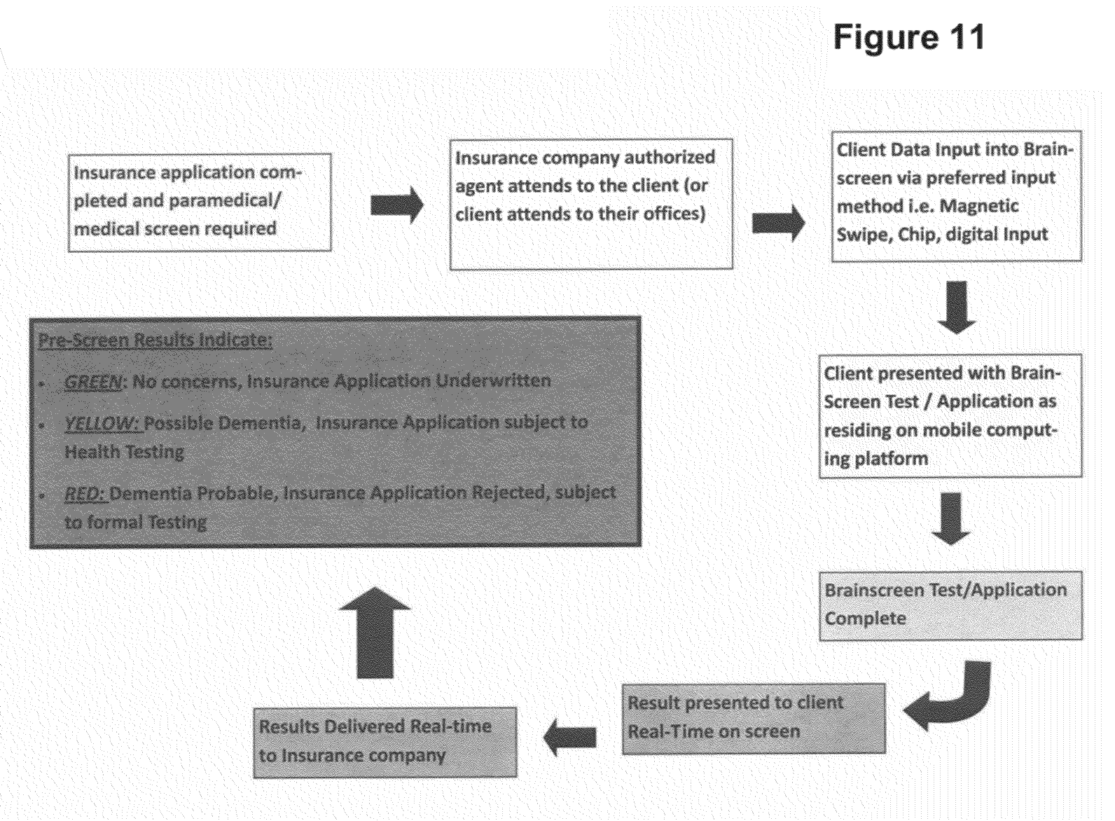

Similarly, the invention may have application for general health or life insurance underwriting as part of the array of tests performed when a Person applies for insurance as shown in FIG. 11. The test can form part of application for insurance, within the Property Casualty Insurance, Life & Health Insurance, General Liability, Directors & Officers, Medical Malpractice or other types of insurance as applicable. The invention may be employed during the underwriting of the policy and during the collection of relevant information for the determination of insurability as it relates to the application and provide appropriate data relating to the Person's cognitive abilities.

As a part of the underwriting process, the Person would be required to complete the cognitive test in real time. A real time response would be given which would determine the outcome of the underwriting process, either allowing that person to continue with the application for insurance process or giving a warning and requiring the person to return within a specified time frame for additional or different testing, or the test could illustrate real concerns and the insurer may determine to not proceed with the insurance application. At the same time, the result of the test would be communicated to the appropriate agency overseeing the application for insurance subject, of course, to issues of consent and privacy.

Results may be measured against past performances of the Person thus creating a baseline for the Person for year over year results and the results can be measured against the population as a whole. Mandatory repeated screening may occur over specified intervals such as year over year, or every 5 years as indicated by the outcome of the test.

The test according to the invention provides easy affordable means for the initial collection and storage of data and provides insuring agencies and companies with information as to whether further testing may be required.

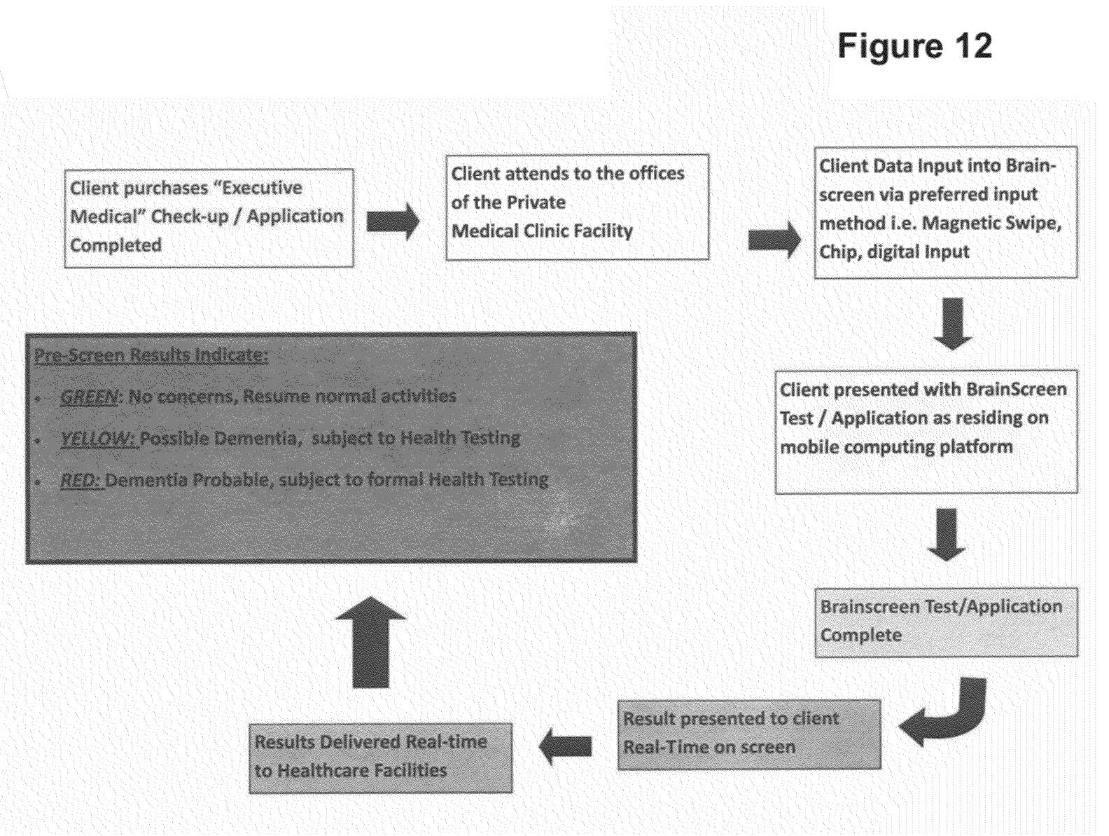

The test according to the invention may also have application in public or private healthcare facilities which healthcare workers may utilize with the overall assessment and diagnosis of persons as shown in FIG. 12. It may be employed during the routine medical examinations and physicals as part of overall evaluation of one's health and provide appropriate data relating to the patient's cognitive abilities. As a part of the examination, the Person would be required to complete the cognitive test in real time. A real time response would be provided to the test subject and healthcare facility. At the same time the result of the test would be communicated to an appropriate agency always, of course, subject to issues of consent and privacy.

Results may be measured against past performances thus creating a baseline for the individual for year over year results and measured against the population as a whole. Mandatory repeated screening may occur over specified intervals such as year over year or every 5 years, as indicated by the outcome of the test. The test provides easily accessible and affordable means for the initial collection and storage of data and provides healthcare facilities and agencies with information as to whether further testing may be required.

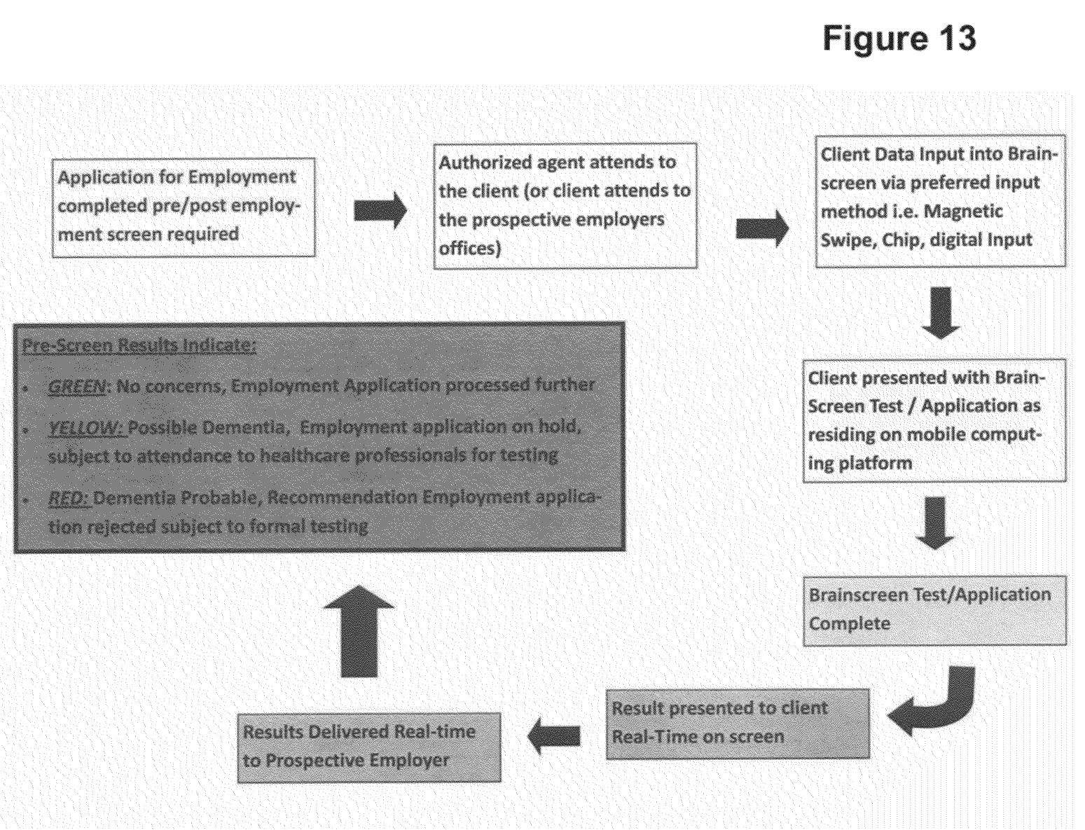

Another application is the use of the test as part of a pre and post employment screening program to identify pre-existing dementia or neurodegeneration as shown in FIG. 13. As described above, the test can form part of a national or international cognitive screening model with cooperation with applicable government agencies.

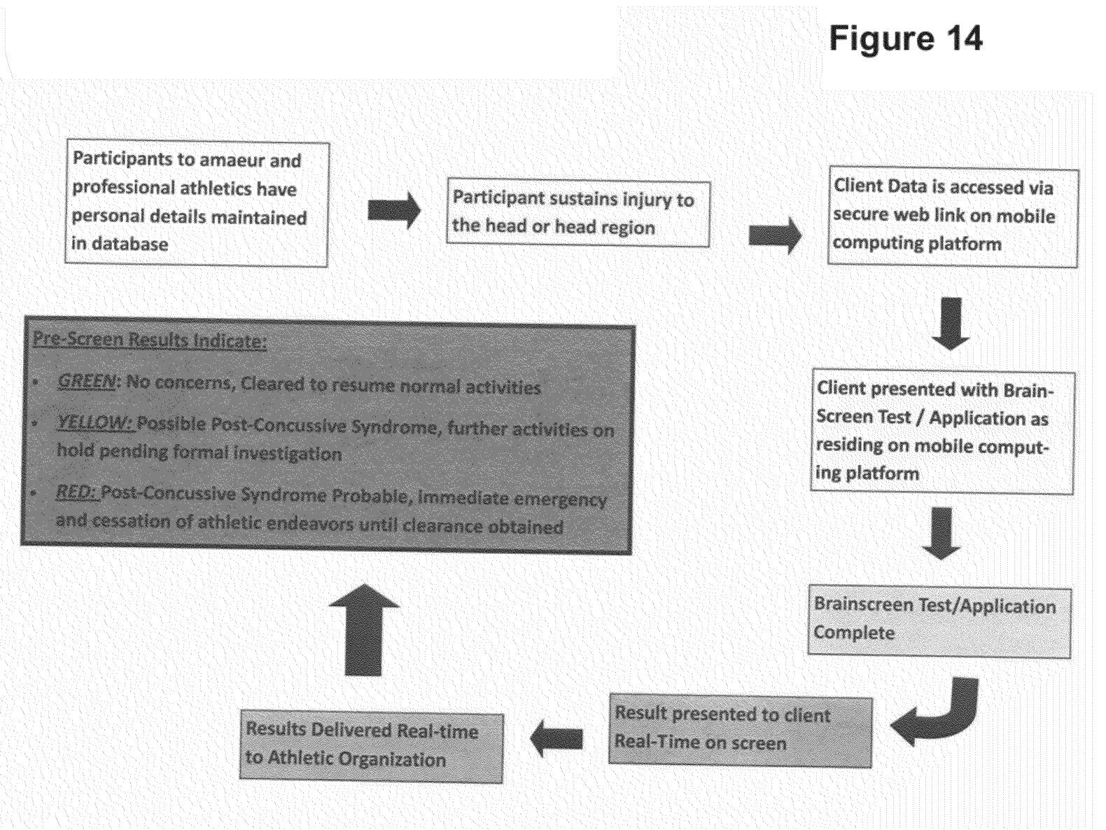

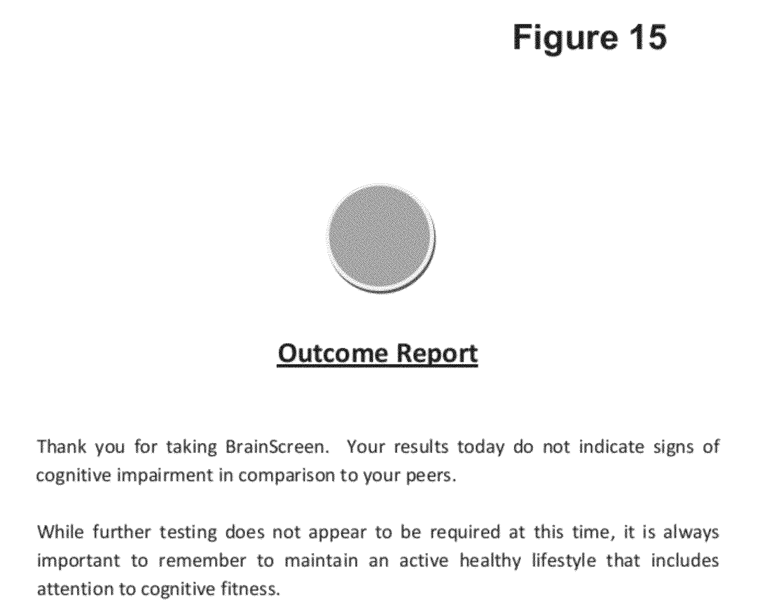

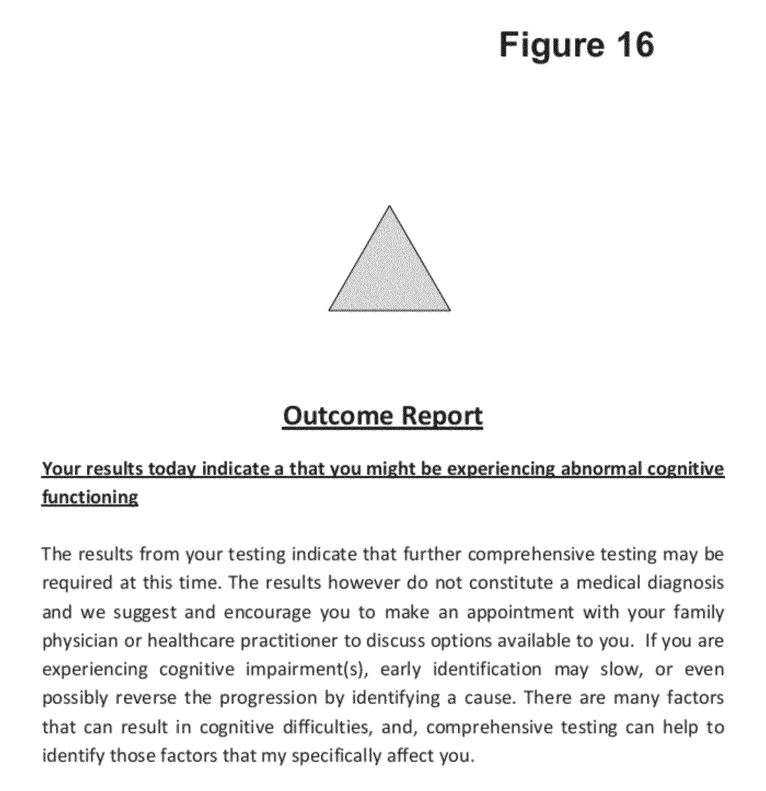

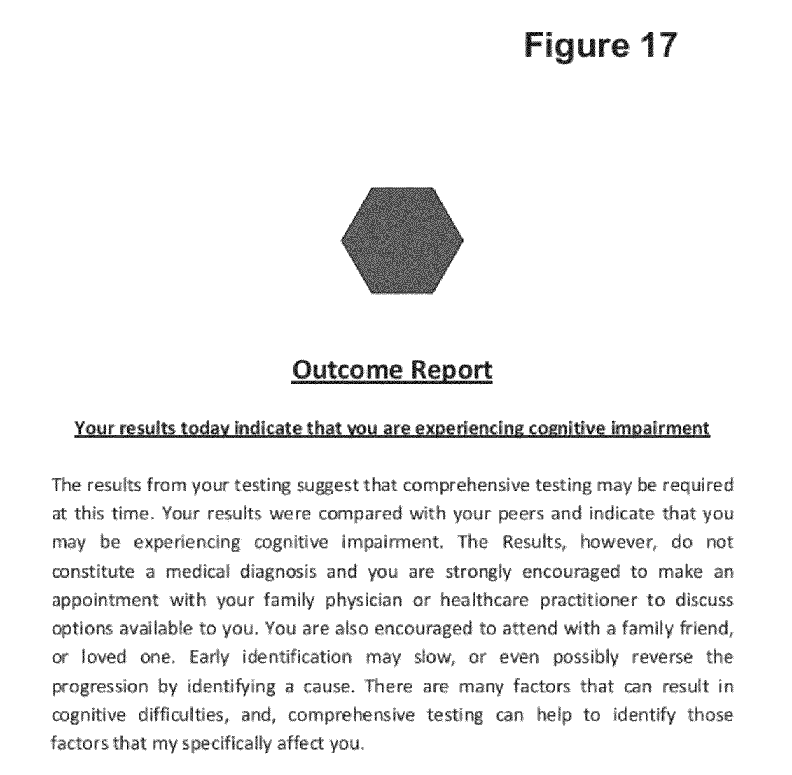

Professional and amateur athletes have accidents on the field of play. A portable on the spot cognitive test would allow a coach or parent to administer the test according to this invention to assist in determining whether the player can return to the field, or be referred to a medical professional as shown in FIG. 14. The test can also function to measure against past test performance and establish baseline testing in sport endeavours. An athlete would take the cognitive test pre-season before commencing athletic endeavours, at the midpoint of the season and then at the conclusion of the season and the cycle would continue at those specific time points. Should an incident occur that results in possible injury to cognitive function such as a likely concussion, the cognitive test would be administered and outcome measured against the athlete's past performance as well as the entire population.

As a part of the intake or pre-season medical examination, the athlete would be required to complete the cognitive test in real time. A real time response would be provided to the athlete as well as the sports team and related association or organization. Results may be measured against past performances thus creating a baseline for the individual for year over year results and measured against the population as a whole. Mandatory repeated screening may occur over specified intervals such as year over year or every 5 years, as indicated by the outcome of the test. The invention provides easily accessible and affordable means for the initial collection and storage of data and provides athletes, teams and sports organizations information which will assist in making decisions in the field and indicate whether further testing may be required.

Other advantages which are inherent to the invention are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method of automatically processing an application made by a person to a third party for the purpose of obtaining the third party's license, consent or approval to said application for an intended purpose comprising the steps of
administering a computer implemented cognitive test to a person at a test location and time said test consisting of a group of questions randomly selected from a question database including questions specific to said intended purpose.
obtaining answers from the person to said group of questions
evaluating the answers in real time to obtain a test score
comparing the test score to a normed score to obtain a test result
using the test result to inform a decision for continuing or adjourning or terminating the application process.

2. The method of claim 1, wherein said test location has communication means, wherein the test score is communicated to and stored in a remotely located database through said communication means and wherein said normed score is calibrated in response to said stored test scores.

3. The method of claim 1, wherein said test location is a kiosk unit.

4. The method of claim 3, wherein said kiosk unit has communication means, wherein the test score is communicated to and stored in a remotely located database through said communication means and wherein said normed score is calibrated in response to said stored test scores.

5. The method of claim 1, wherein said test is available in multiple languages.

6. The method of claim 1, wherein said test score is determined by the accuracy of said answers and the time required to obtain said answers.

7. The method of claim 4, wherein said application is for obtaining or renewing a driver's license.

8. The method of claim 2, wherein said application is for obtaining insurance coverage.

9. The method of claim 2, wherein said application is for obtaining employment.

10. A method of automatically evaluating a person's ability to continue a physical activity upon sustaining a suspected head injury at a location comprising the steps of
administering a computer implemented cognitive test to a person at the location and time following said injury, said test consisting of a group of questions randomly selected from a question database including questions specific to said injury
obtaining answers from the person to said questions
evaluating the answers in real time to obtain a test score
comparing the test score to a normed score to obtain a test result
using the test result to inform a decision on whether to permit the person to continue the physical activity after the injury or to stop.

11. The method of claim 10, wherein said test is administered at a time immediately following said injury.

12. The method of claim 10, wherein said location has communication means, wherein the test score is communicated to and stored in a remotely located database through said communication means and wherein said normed score is calibrated in response to said stored test scores.

13. A method of automatically testing and recording a person's cognitive ability at a time or location comprising the steps of
administering a computer implemented cognitive test to a person at the location or time, said test consisting of a group of questions randomly selected from a question data base.
obtaining answers from the person to said questions
evaluating the answers to obtain a test score
comparing the test score to a normed score to obtain a test result
storing the test results in a database.
